(19) United States
(12) Patent Application Publication
(10) Pub. No.: US 2013/0024602 A1
(43) Pub. Date: Jan. 24, 2013

(54) Universal Storage for Information Handling Systems

(71) Applicants: William F. Sauber, (US); Richard W. Schuckle, (US)

(72) Inventors: William F. Sauber, (US); Richard W. Schuckle, (US)

(73) Assignee: DELL PRODUCTS L.P., Round Rock, TX (US)

(21) Appl. No.: 13/185,201

(22) Filed: Jul. 18, 2011

(51) Int. Cl. G06F 12/00

(52) U.S. Cl. 711/103; 711/E12.008

(57) ABSTRACT

An information handling system (IHS) includes a processor and a single universal storage device with a system memory region and a mass storage region, wherein disk commands are executed by the processor as transfers between the system memory region and the mass storage region.

### TECHNICAL HELD

The present disclosure relates generally to the field of information handling systems, and, c yore specifically, to methods to improve operating system (OS) compatibility pertaining to information handling systems.

### BACKGROUND

As the magnitude and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the magnitude of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for such systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems,

With the development of memory technology for information handling systems (IHSs), alternate semiconductor storage technologies such as phase change memory are expected to provide advantages such as longer data retention times, improved endurance of memory, and improved performance, to name a few. Such advantages may allow for an improved memory architecture containing only a new single universal memory device within an IHS.

As the conventional memory architecture containing a separate system memory device and a mass storage device is replaced with an improved memory architecture containing a single universal memory device encompassing both the system memory device and mass storage device, the improved memory architecture may encounter issues regarding compatibility with current operating system (OS) architectures. Current OS architectures may utilize separate storages, such as a page mapped linear address space based working storage and a separate disk based file systems for persistent storage. Thus, a need may exist for the improved memory architecture to mimic the current system memory and mass storage memory architecture for satisfying the basic operational requirements of the existing OS architecture.

### SUMMARY

The following presents a general summary of several aspects of the disclosure in order to provide a basic understanding of at least some aspects of the disclosure. This summary is not an extensive overview of the disclosure. It is not intended to identify key or critical elements of the disclosure or to delineate the scope of the claims. The following summary merely presents some concepts of the disclosure in a general form as a prelude to the more detailed description that follows.

One aspect of the present disclosure provides an information handling system (INS) with a processor and a single universal storage device. The single universal storage device includes a system memory region and a mass storage region, wherein disk commands are executed by the processor as transfers between the system memory region and the mass storage region.

Another aspect of the present disclosure provides an information handling system including a single universal storage device, a processor, and firmware executable by the processor. The firmware is configured to partition the single universal storage device into a system memory region and a mass storage region.

Yet another aspect of the present disclosure provides a computer-implemented method including partitioning, by a processor of an information handling system, a single universal storage device into a system memory region and a mass storage region.

### BRIEF DESCRIPTION OF THE DRAWINGS

For detailed understanding of the present disclosure, references should be made to the following detailed description of the several aspects, taken in conjunction with the accompanying drawings, in which like elements have been given like numerals and wherein:

FIG. 1 represents an information handling system in accordance with one aspect of the present disclosure;

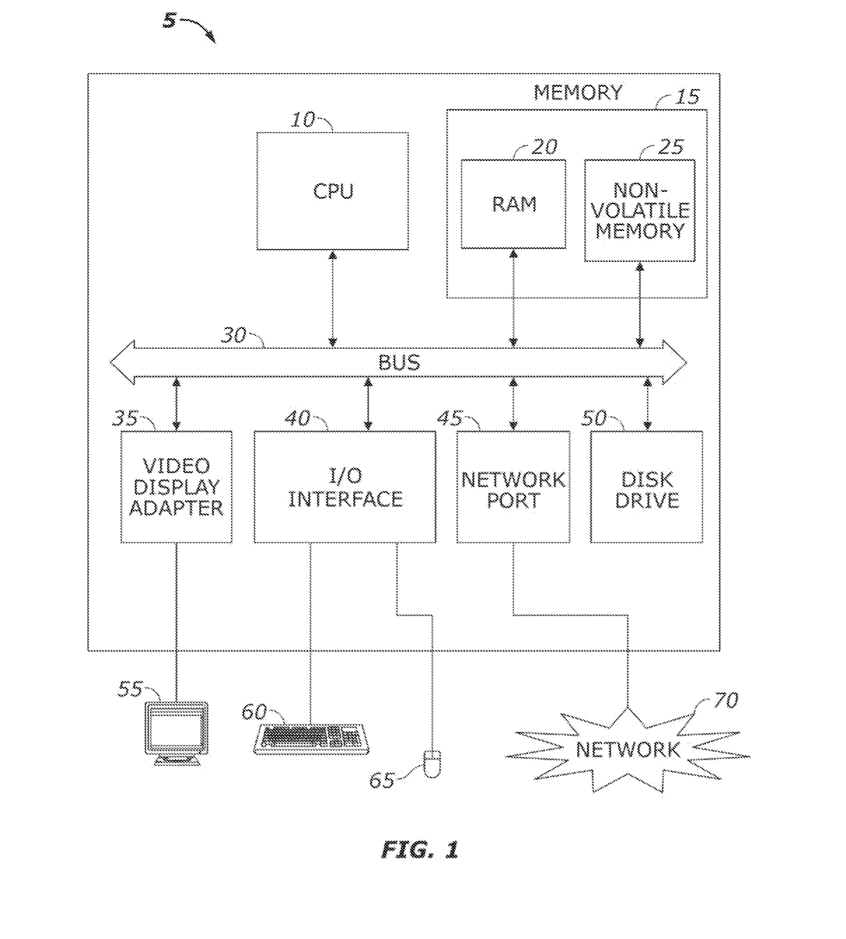

FIG. 2 illustrates a conventional memory architecture within an information handling system;

FIG. 3 illustrates an improved memory architecture within an information handling system in accordance with one aspect of the present disclosure;

FIG. 4A illustrates a universal Memory in accordance with one aspect of he present disclosure;

FIG, 4B illustrates a partition process of the universal memory of FIG. 4A;

FIG. 5 illustrates a translation process performed by the improved memory architecture of FIG. 3; and

FIG. 6 illustrates a method of using SATA commands as part of a translation process performed by the improved memory architecture of FIG. 3

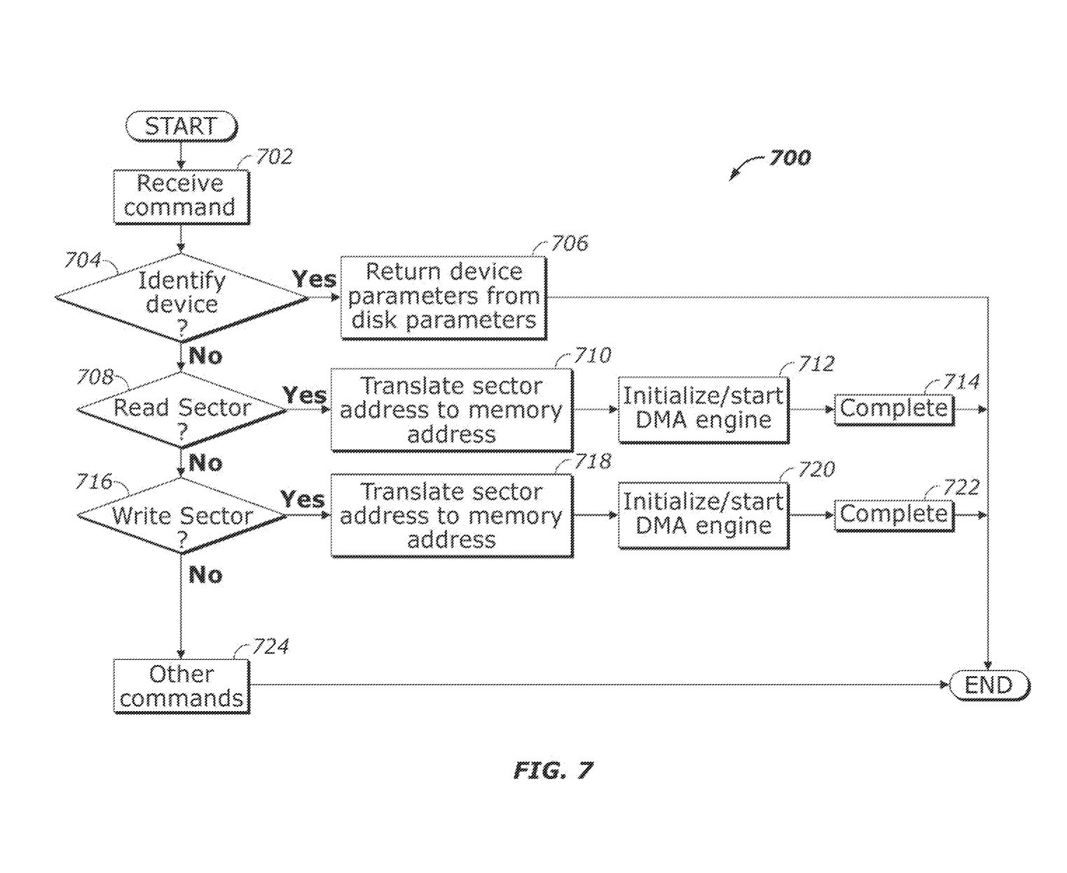

### DETAILED DESCRIPTION

Before the present systems and methods are described, it is to be understood that this disclosure is not limited to the particular systems and methods, as such may vary. Also, the present disclosure is not limited in its application to the details of construction, arrangement or order of components and/or steps set forth in the following description or illustrated in the figures. Thus, the disclosure is capable of other aspects, embodiments or implementations or being carried out/practiced in various other ways.

One of ordinary skill in the art should understand that the terminology used herein is for the purpose of describing possible aspects, embodiments and/or implementations only, and is not intended to limit the scope of the present disclosure which will be limited only by the appended claims. Further, use of terms such as “including”, “comprising”, “having”, “containing”, “involving”, “consisting”, and variations thereof are meant to encompass the listed thereafter and equivalents thereof as well as additional items.

It must also be noted that as used herein and in the appended claims, the singular forms “a” “and,” and “the” may include plural referents unless the context clearly dictates otherwise. Thus, for example, reference to “a port” refers to one or several ports and reference to “a method of regulating” includes reference to equivalent steps and methods known to those skilled in the art, and so forth.

For purposes of this disclosure, an embodiment of an Information Handling System (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

FIG, 1 illustrates one possible implementation of an IHS 5 comprising a CPU 10. It should be understood that the present disclosure has applicability to IHSs as broadly described above, and is not intended to be limited to the IHS 5 as specifically described. The CPU 10 may comprise a processor, a microprocessor, minicomputer, or any other suitable device, including combinations and/or a plurality thereof, for executing programmed instructions. The CPU 10 may be in data communication over a local interface bus 30 with components including memory 15 and input/output interfaces 40. The memory 15, as illustrated, may include non-volatile memory 25. The non-volatile memory 25 may include, but is not limited to, firmware flash memory, non-volatile random access memory (NVRAM), and electrically erasable programmable read-only memory (EEPROM). The non-volatile memory 25 may contain a firmware program (not shown) which may contain programming and/or executable instructions required to control a keyboard 60, mouse 65, video display 55 and/or other input/output devices not shown here. This type of firmware may be known as a basic/input output system (BIOS). The memory may also comprise random access memory (RAM) 20. The operating system and application programs (e.g., graphical user interfaces) may be loaded into the RAM 20 for execution.

The IHS 5 may be implemented with a network port 45 to permit communication over a network 70 such as a local area network (LAN) or a wide area network (WAN), such as the Internet. As understood by those skilled in the art, IHS 5 implementations may also include an assortment of ports and interfaces for different peripherals and components, such as video display adapters 35, disk drives 50, and input/output interfaces 40 (e.g., keyboard 60, mouse 65).

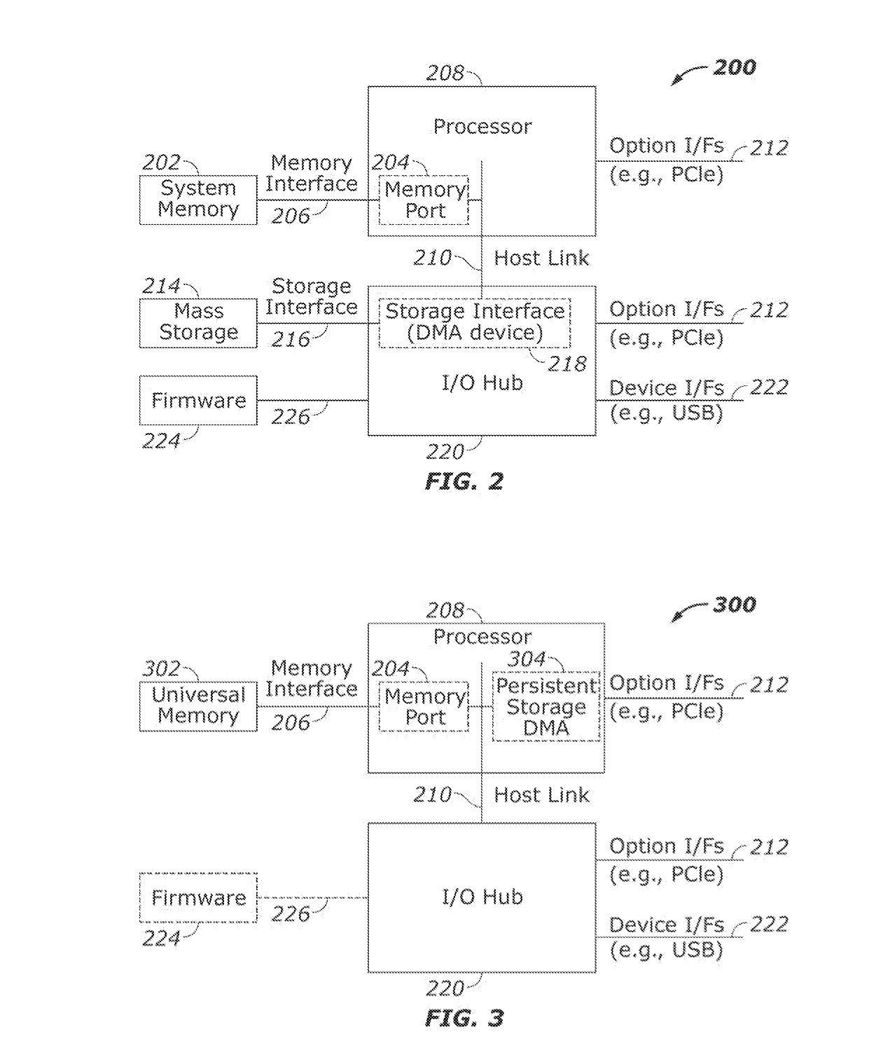

Turning now to FIG. 2, illustrated within an IHS is a conventional memory architecture, indicated generally at 200. As part of the conventional memory architecture 200, a system memory 202 may be coupled via a memory interface 206 to a memory port 204 residing within the processor 208. The conventional memory architecture 200 may further include mass storage 214 coupled to the processor 208 through a host link 210 and a storage interface 216 both coupled to an input/output hub (I/O hub) 220. The host link 210 and the storage interface 216 may be coupled to a storage interface 218, such as a direct memory access (DMA) device 218 residing within the 110 hub 220. Further within the conventional memory architecture, firmware 224 may be coupled to the I/O hub 220 through an interface bus 226 (e.g., serial peripheral interface bus (SPI)). The processor 208 may contain other option interfaces (I/Fs) 212 for functions or features which may be needed, such as PCIe interfaces. Similarly, option interfaces 212 may be provided in the I/O hub 208, wherein the I/O hub 208 may further contain device interfaces (I/Fs) 222 for additional devices which may be required, such as universal serial bus (USB) devices.

Typically, two types of storages are provided in the conventional memory architecture 200. Dynamic random access memory (DRAM), as one example, may be provided for system memory 202, also known as working memory for providing data to the processor as required during typical processor operations. The structural simplicity of DRAM, considered as an advantage of such, allows DRAM to reach relatively high data transfer speeds. DRAM may be a volatile type memory, which does not maintain data in the memory when the IHS is powered down. The data transfer speed of DRAM and its volatility may make DRAM a suitable storage medium for system memory as it requires high transfer speeds and negligible data retentiveness when the supply voltage of the IHS is turned off.

A hard disk drive (HDD) is an example of mass storage (i.e., persistent storage) for its relative non-volatility and inexpensiveness as compared to other alternative storage media. Unlike system memory 202, mass storage 214 may not be directly accessible by the processor 208. As FIG. 2 shows, the IHS may utilize its I/O channels to access mass storage 214 and may transfer any desired data using system memory 202. An HOD is an example of a storage device divided into logical blocks which may also be referenced through sector addressing.

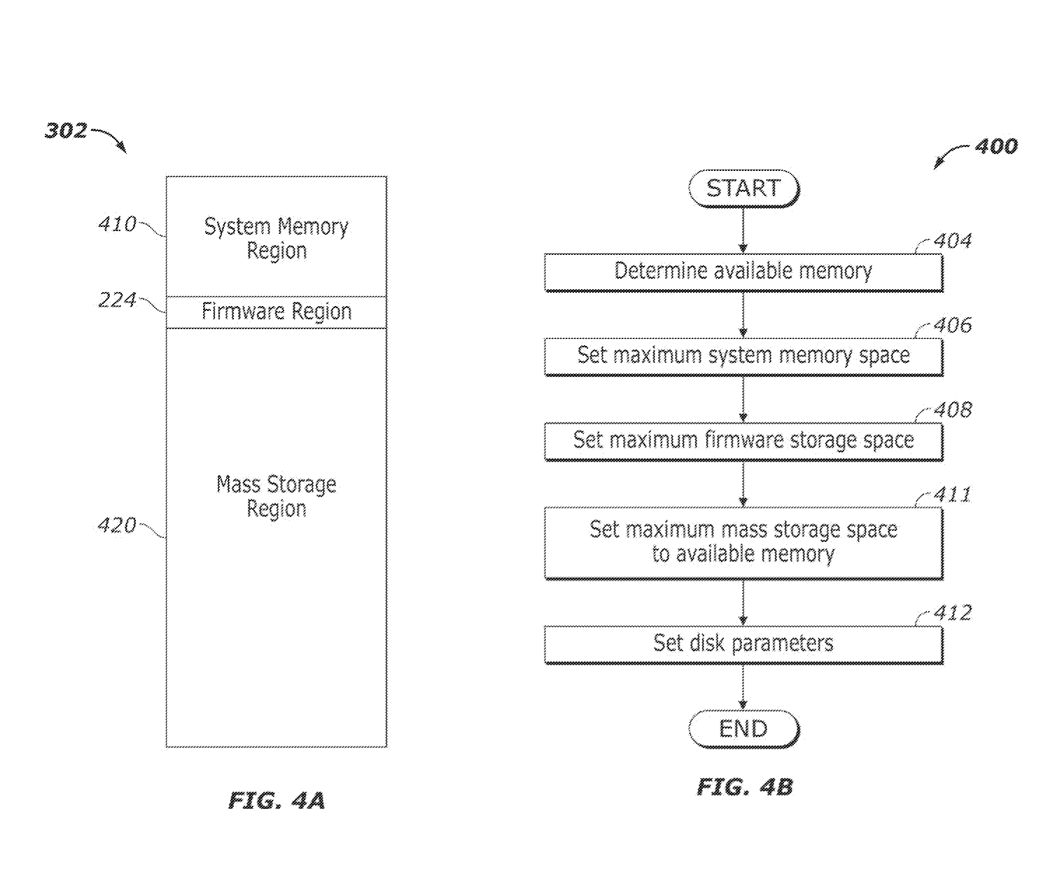

Turning now to FIG. 3, shown is an improved memory architecture, indicated generally at 300, utilizing a single universal memory 302. The universal memory 302 may be coupled via a memory interface 206 to a memory port 204 disposed within the processor 208. A persistent storage direct memory access (DMA) device 304 may be also disposed within in the processor 208 for transferring desired data between system memory and persistent storage. The DMA engine is an example of an I/O which may run parallel with, i.e., offload, the processor 208 and is required by some OS's. In the improved memory architecture 300, DMA 304 may be optional. Such a memory to memory DMA can be alternatively implemented by using firmware and/or software (e.g., memory architecture aware operating system (OS)) to transfer data between system memory and mass storage. Firmware 224 may be coupled through an interface bus 226 (e.g., serial peripheral interface bus (SPI)) to an I/O hub 220. I/O hub 220 may further be coupled to the processor 208 via a host link 220. Similarly as shown in FIG. 2, processor 208 may contain other option interfaces (I/Fs) 212 for functions or features which may be needed, such as PCIe interfaces. Option interfaces may be provided to the I/O hub 220, wherein the I/O hub 220 may further contain device interfaces (I/Fs) 222 for additional devices which may be required, such as USB devices.

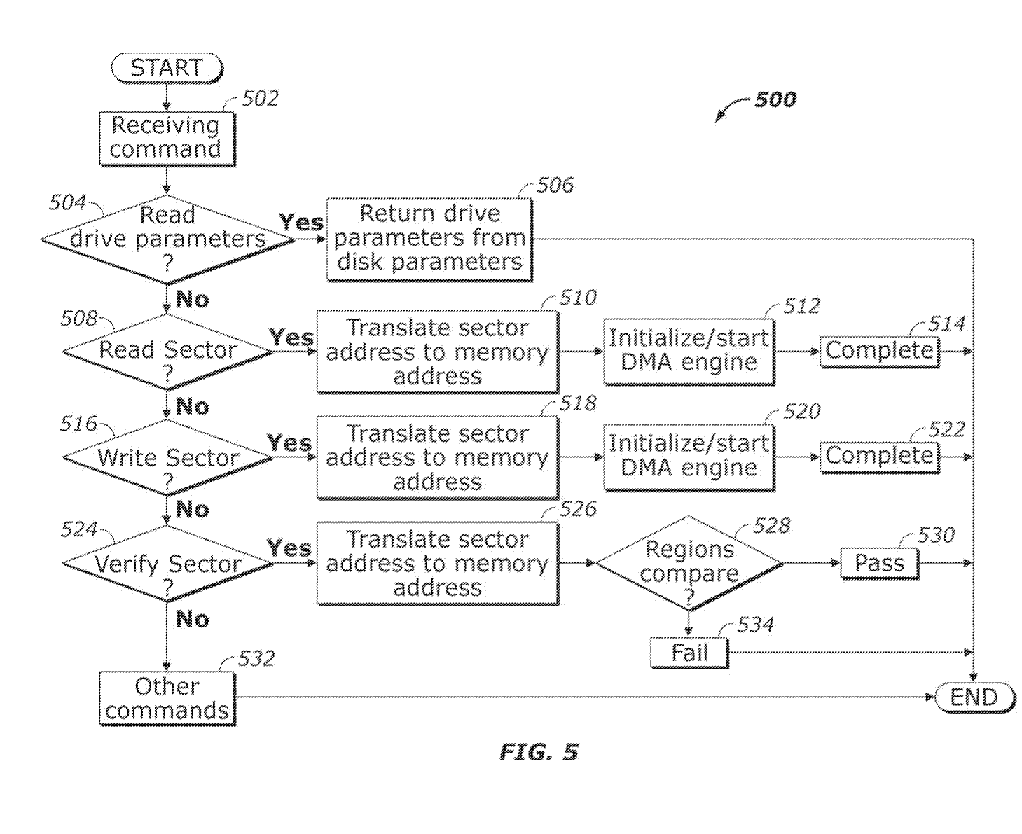

Taking full advantage of relative non-volatility and high data transfer speed, the improved memory architecture, employing a single universal memory 302, no longer requires system memory 202 and mass storage 214 to be two physically separated devices, as seen in FIG. 2. However, for backward compatibility with existing OS developed on systems employing the conventional memory architecture having system memory and mass storage as separate device, the universal memory 302 may be required to be partitioned into two storage regions, a system memory region 410 and a mass storage region 420, for example, as shown in FIG. 4b. The system memory region 410 may be used for working storage whereas the mass storage region 420 may be utilized for persistent storage. Universal memory 302 may be further partitioned to include an additional region reserved for firmware 224 as well as both a primary storage region and a secondary storage region. Such a firmware 224 region can also be used as storage and execution of the system BIOS.

The single universal storage device, shown as universal memory 302, may consist of various types of memory, such as phase-change memory, as one example. Phase-change memory may include memory forms which can switch between various states such as crystalline and amorphous, from the application of heat produced by the passage of electric current. Phase-change memory may include, but is not limited to, PCME, PRAM, PCRAM, Ovonic Unified Memory, Chalcogenide RAM, C-RAM, and the like.

For installation and typical operation, a portion of the universal memory 302 must be presented to the OS as a storage device. Other portions of the universal memory 302 may be presented as system memory, Communicating or presenting portions of the universal memory 302 as system memory may be accomplished through conventional methods such as those described in the Advanced Configuration and Power Interface (ACPI) specification. As part of a manufacturing process, for example, a universal memory partition, such as that illustrated in FIG. 4A, must be created and must appear to the OS as storage device both for formatting and typical operation.

FIG.4B illustrates a partitioning process 400 executed by system firmware to create the universal memory 302 shown in FIG. 4A. The system firmware, executable by the processor, may support partitioning of the universal memory 302 into system memory (i.e., working storage) and mass storage (Le., persistent storage). The code used to execute the partitioning process may be preloaded in the universal memory 302 or stored in a device on the serial peripheral interface (SPI) and may be transferred to other regions of universal memory 302 or processor cache for execution. Available memory within the universal memory 302 is then determined in step 404. This may be accomplished by writing and then reading each physical address sequentially until the data read does not match the data written. Alternatively, an operator input could be used. The partition code may further set maximum system memory space in step 406, maximum firmware storage space in step 408 and maximum mass storage space in step 411. This may be accomplished by using percentages of total universal memory space, operator, or automated configuration inputs. The firmware storage space might be a fixed length or fixed address range. A specific OS will operate with only certain file structures and will create these structures as part of formatting operations during the installation process. In addition, these OSs expect to be able to access drive parameters for some of their low level commands. A data structure is created in step 412 to allow the firmware to respond to these commands by mimicking the drive parameters of a solid-state drive (SSD), for example. That is, a parameter such as storage space would be represented in a format consistent with the drive to be mimicked. This provides the necessary universal memory structure for INT13h and serial advanced technology attachment (SATA) commands to be used to retrieve mimicked drive information. At the conclusion of the partition process, the system memory region 410, the mass storage region 420, and the firmware region 224 are well defined and OS Installation may be initiated.

Existing OS architecture may utilize a page mapped linear address space based on system memory and a separate disk based file system for mass storage. in the improved memory architecture utilizing a single universal memory, a mass storage region may be a linear address storage space rather than a disk based file system storage space. Therefore, to support an existing OS, it may be necessary to translate a disk sector address within a conventional disk based file system storage space to a memory address within a linear memory storage space. This process may occur during both OS installation and normal operations. Persistent storage DMA (304) may work in conjunction with firmware running on the processor to support INT13 commands for formatting, for example, and SATA commands for normal operation, for example.

In one possible implementation, an INT13h call may be used to access the mass storage region 420 of the universal memory 320, triggering translation of addresses of a conventional disk based file system storage to addresses in a linear memory space. Existing operating systems may utilize BIOS interrupt calls to invoke the BIOS facilities to probe and initialize hardware resources during OS installation and early stages of booting an IHS. In particular, INT13h is an interrupt vector in an x86 based IHS, which refers to a low level disk service interrupt call. Under a real mode operating system,calling INT13h would invoke the computer's BIOS code for low level disk services, which will carry out sector-based disk read or write functions for the program. The earlier mentioned firmware optionally in conjunction with a DMA engine contained in the improved memory architecture disclosed herein may reasonably include an INT13h handler for properly responding to INT13h commands.

As mentioned herein, INT 13h is merely one example of a BIOS interrupt call, particularly the 20^{th} interrupt vector in an x86-based information handling system. The BIOS may set up a real mode interrupt handler at the 20^{th} vector that provides sector based hard disk and floppy disk read and write services using cylinder-head-sector (CHS) addressing. Generally, INT is one example of an x86 instruction that triggers a software interrupt, and a 13 hex vector passed to the instruction.

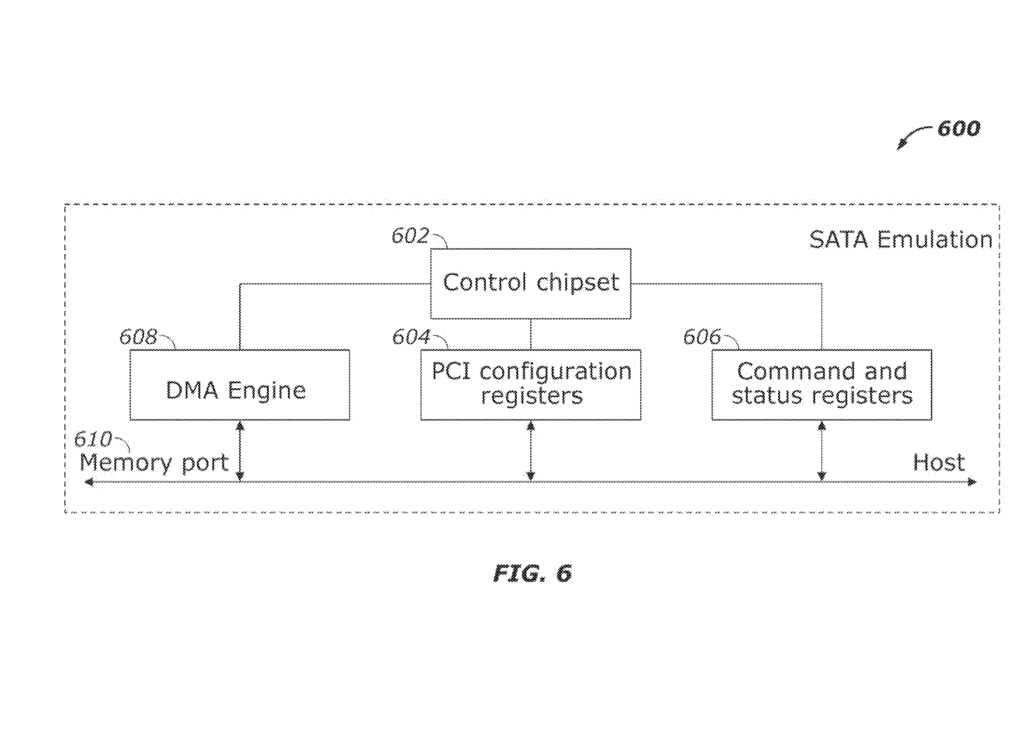

Turning now to FIG. 5, illustrated is a flowchart depicting a translation process 500 performed by the improved memory architecture of the present disclosure. Particularly shown, the translation process 500 may utilize INT13h commands as one possible mechanism to implement translating disk commands in a conventional disk based file system storage space to commands in a universal memory based storage space. However,the present disclosure is also applicable to various other commands and/or handlers, other than INT13h.

Generally, disk commands generally may include, but are not limited to, reset disk drives, check drive status, read sectors from drive, write sectors from drive, verify sectors on drive, format track on drive, retrieve drive parameters, and the like. Furthermore, a disk command may move disk data, which may refer to data in files that the processor may want to transfer between system memory and mass storage. A disk command may also retrieve information (i.e., disk parameters) related to mass storage, or perform various specific disk commands, such as SATA or INT 13h, for example. In the present implementation shown in FIG. 5, only three INT13h commands are listed for demonstrating the translating process but it should be understood that various other INT13h commands may be contemplated by the present disclosure. As used herein, disk command data may refer to the data transferred between system memory and mass storage as a result of a specific disk command.

At the beginning of the translating process, in step 502, the INT13h handler as earner mentioned receives an INT13h command. It is determined in step 504 whether the INT13h command is to request drive parameters. If it is determined that the INT13h command is to request drive parameters, such command is executed to obtain and return drive parameters from disk parameters in step 506 based on information stored in step 412. If it is determined that the INT13h command is not to request drive parameters, it is further determined in step 508 whether the INT13h command is to read sectors from the drive. To this end, since the universal memory may not include physical sectors, the processor may need to translate a conventional disk sector address into a linear memory address in step 510. Then, in step 512, the processor initializes the direct memory access (DMA) engine and it begins transfer of the desired data. The DMA engine completes reading data in the assigned disk sector and signals complete to the processor in step 514. As such, data transfer between a mass storage section and system memory section of the universal memory may occur. If it is determined that the INT13h command is not to request reading sectors from a drive, it is then determined in step 516 whether the INT13h command is to request writing sectors to a drive. If it is determined that the INT13h command is to request writing a sector to a drive, the processor firmware may translate a conventional disk sector address into linear memory address in step 518. To this end, disk commands such as INT13h or SATA commands, for example are converted to memory accesses. Then, the processor may initialize the DMA engine and it begins the transfer of the desired data in step 520. Then in step 522, data writing to the desired memory address is completed and complete is signaled to the processor firmware. If it is determined that the INT13h command is not to request writing a sector to the drive section of the universal memory, execution of other commands is represented at step 532.

Turning now to FIG. 7, illustrated is a flowchart depicting a translation process 700 performed by the improved memory architecture of the present disclosure. Particularly shown, the translation process 700 may utilize SATA commands, as one possible mechanism, to implement translating disk commands of a conventional disk based file system storage space to commands in a universal memory based storage space. However, the present disclosure is also applicable to various other commands and/or handlers, other than SATA.

SATA commands generally may include, but are not limited to, reset disk drives, check drive status, read sectors from drive, write sectors from drive, verify sectors on drive, format track on drive, retrieve drive parameters, and the like. In the present implementation shown in FIG. 7, only three SATA commands are listed for demonstrating the translating process but it should be understood that various other SATA commands may be contemplated by the present disclosure.

At the beginning of the translating process. In step 702, the SATA handler as earlier mentioned receives an SATA command. It is determined in step 704 whether the SATA command is to request drive parameters. If it is determined that the SATA command is to request drive parameters, such command is executed to obtain and return drive parameters from disk parameters in step 706 based on information stored in step 412 If it is determined that the SATA command is not to request drive parameters, it is further determined in step 708 whether the SATA command is to read sectors from the drive. To this end, since the universal memory may not include physical sectors, the processor may need to translate a conventional disk sector address into a linear memory address in step 710. As an example, firmware of the present disclosure may operate with the system memory region 410 and mass storage region 420 to support working storage address or system memory address ranges to the OS. Then, in step 712, the processor initializes the direct memory access (DMA) engine and it begins transfer of the desired data. The DMA engine completes reading data in the assigned disk sector and signals complete to the processor in step 714. As such, data transfer between a mass storage section and system memory section of the universal memory may occur. If it is determined that the SATA command is not to request reading sectors from a drive, it is then determined in step 716 whether the SATA command is to request writing sectors to a drive. If it is determined that the SATA command is to request writing a sector to a drive, the firmware may translate a conventional disk sector address into linear memory address in step 718. Then, the processor may initialize the DMA engine and it begins the transfer of the desired data in step 720. Then in step 722, data writing to the desired memory address is completed and completion of the data writing is signaled to the firmware. If it is determined that the SATA command is not to request writing a sector to the drive section of the universal memory, execution of other commands is represented at step 532.

The solutions provided herein provide hardware, firmware, and software to mimic the mass storage and system memory partitions into a single universal physical memory. The present disclosure further contemplates firmware that mimics a disk to support OS installation and basic OS disk operations (e.g., INT13h support). The firmware may further support a manufacturing process which partitions the universal physical memory into mass storage and system memory partitions. Therefore, as set forth above, the single universal memory architecture can be implemented in various ways to be backward compatible with an existing OS.

Furthermore, methods of the present disclosure, detailed description and claims may be presented in terms of logic, software or software implemented aspects typically encoded on a variety of storage media or storage medium including, but not limited to, computer-readable storage medium/media, machine-readable storage medium/media, program storage medium/media or computer program product. Such storage media, having computer-executable instructions stored thereon, may be handled, read, sensed and/or interpreted by an IHS, such as a computer. Generally, computer-executable instructions, such as program modules, may include routines, programs, objects, components, data structures, and the like, which perform particular tasks, carry out particular methods or implement particular abstract data types. Those skilled in the art will appreciate that such storage media may take various forms such as cards, tapes, magnetic disks (e.g., floppy disk or hard drive) and optical disks (e.g., compact disk read only memory (“CD-ROM”) or digital versatile disc; (“DVD”)). It should be understood that the given implementations are illustrative only and shall not limit the present disclosure.

Although the present disclosure has been described with reference to particular examples, embodiments and/or implementations, those skilled in the art will recognize that modifications and variations may be made without departing from the spirit and scope of the claimed subject matter. Such changes in form and detail, including use of equivalent functional and/or structural substitutes for elements described herein, fall within the scope of the appended claims and are intended to be covered by this disclosure.

What is claimed is:

1. An information handling system (IHS) comprising:
a processor; and
a single universal storage device comprising a system memory region and a mass storage region, wherein disk commands are executed by the processor as transfers between the system memory region and the mass storage region,

2. The system of claim 1 further comprising firmware to partition the single universal storage device into the system memory region and the mass storage region.

3. The system of claim 2, wherein the firmware is executable by the processor.

4. The system of claim 1, wherein the processor comprises a direct memory access (DMA) device for performing data transfers requested by the disk commands.

5. The system of dam 1, wherein the disk commands are BIOS interrupt calls.

6. The system of claim 1, wherein the disk commands are INT13h commands.

7. The system of claim 1, wherein the disk commands are serial advanced technology attachment (SATA) commands.

8. The system of claim 1, wherein the single universal storage device is phase change memory.

9. An information handling system comprising:
a single universal storage device;
a processor; and
firmware executable by the processor, the firmware configured to partition the single universal storage device into a system memory region and a mass storage region.

10. The system of claim 9, wherein the processor comprises a direct memory access (DMA) device for transferring disk command data between the system memory region and the mass storage region.

11. The system of claim 9, wherein the processor translates a BIOS interrupt call to a data transfer in a universal memory based storage space.

12. The system of claim 9, wherein the processor translates an INT13h command to a data transfer in a universal memory based storage space.

13. The system of claim 9, wherein processor translates a serial advanced technology attachment (SATA) command to a data transfer in a universal memory based storage space.

14. The system of claim 9, wherein a single universal storage device is phase change memory.

15. A computer-implemented method comprising:
partitioning, by a processor of an information handling system, a single universal storage device into a system memory region and a mass storage region.

16. The method of claim 15 further comprising:
transferring a data between the system memory region and the mass storage region within the single universal storage device.

17. The computer-implemented method of claim 15 further comprising:
translating an INT13h command to a data transfer in a universal memory based storage space.

18. The computer-implemented method of claim 15 further comprising:
translating a serial advanced technology attachment (SATA) command to a data transfer in a universal memory based storage space.

19. The computer-implemented method of claim 15, wherein the single universal storage device is phase change memory.

20. The computer-implemented method of claim 15, wherein the processor comprises a direct memory access (DMA) device for transferring the data between the system memory region and the mass storage region within the single universal storage device.
